(19) United States
(12) Patent Application Publication
(10) Pub. No.: US 2006/0038330 A1
(43) Pub. Date: Feb. 23, 2006

(54) Vehicle powertrain mounting system and method

(76) Inventors: Michael G. Zimmerman, Dayton, OH (US); David J. Koester, Miamisburg, OH (US); James P. Hamberg, Tipp City, OH (US); Sanjiv G. Tewani, Lebanon, OH (US); David J. Barta, Beavercreek, OH (US); Ronald A. Beer, Fairborn, OH (US); Patrick N. Hopkins, Farmington Hills, MI (US)

Correspondence Address: Delphi Technologies, Inc.;Legal Staff-IP, M/C 480-410-202, P. O.box 5052, Troy, MI, 48007-5052, US

(21) Appl. No.: 10/922,579

(22) Filed: Aug. 20, 2004

(51) Int. Cl. F16F 15/00

(52) U.S. Cl. 267/140.14

(57) ABSTRACT

In July of 2004 KTH Racing will attend at the Formula Student event in England. The Formula Student event is a competition between schools that has built their own formula style race cars according to the Formula SAE rules. In January of 2004 the Formula Student project started at KTH involving over seventy students. The aim of this thesis work is to design the suspension and steering geometry for the race car being built. The design shall meet the demands caused by the different events in the competition. The design presented here will then be implemented into the chassis being built by students participating in the project. Results from this thesis work shows that the most suitible design of the suspension is a classical unequal length double A-arm design. This suspension type is easy to design and meets all demands. This thesis work is written in such a way that it can be used as a guidebook when designing the suspension and steering geometries of future Formula Student projects at KTH.

### TECHNICAL FIELD

The present invention relates generally to vehicle powertrain mounting systems, and more particularly to a vehicle powertrain mounting system including a magnetorheological hydraulic mount and to a method for controlling such a mount in such a system.

### BACKGROUND OF THE INVENTION

A vehicle powertrain includes a vehicle engine and a vehicle transmission. One example of a conventional vehicle powertrain mounting system includes five mounts each attached to the vehicle powertrain and to one or more vehicle weight-supporting members (such as a vehicle frame, a vehicle subframe, or a vehicle body). The first mount is a conventional hydraulic mount attached to a rear portion of the powertrain. The second mount is a conventional hydraulic mount attached to a front portion of the powertrain. The third mount is an elastomeric mount attached to a side portion of the powertrain. A fourth mount is an upper torque strut (restrictor) attached to the powertrain above the center of gravity of the powertrain. A fifth mount is a lower torque strut (restrictor) attached to the powertrain below the center of gravity of the powertrain. The first through third mounts carry loads and the fourth through fifth mounts react engine torque caused by a change in rotational speed of the vehicle engine.

It is known to replace a conventional hydraulic mount with a magnetorheological (MR) hydraulic mount (also called an MR-fluid hydraulic mount) to carry loads. MR hydraulic mount systems, which involve various designs and which are well known in the art, include an MR fluid whose damping effect is varied by changing the electric current to an electric coil which is positioned to magnetically influence the MR fluid and hence the damping effect of the MR fluid.

What is needed is an improved vehicle powertrain mounting system including a magnetorheological hydraulic mount and to a method for controlling such a mount in such a system.

### SUMMARY OF THE INVENTION

In a first embodiment of the invention, a vehicle powertrain mounting system includes a vehicle powertrain and a first magnetorheological (MR) mount. The vehicle powertrain includes a vehicle engine. The first MR hydraulic mount operatively connects the vehicle powertrain to a vehicle weight-supporting member. The first MR hydraulic mount is positioned to carry load and is positioned to react vehicle engine torque during a change in rotational speed of the vehicle engine.

In a second embodiment of the invention, a vehicle powertrain mounting system includes a vehicle powertrain, a first magnetorheological (MR) mount, and a controller. The vehicle powertrain includes a vehicle engine. The first MR hydraulic mount operatively connects the vehicle powertrain to a vehicle weight-supporting member. The first MR hydraulic mount is positioned to carry load and is positioned to react vehicle engine torque during changes in rotational speed of the vehicle engine. The first MR hydraulic mount includes a first electric coil. The controller controls electric current to the first electric coil. The controller supplies electric current to the first electric coil during bounce of the vehicle engine, and/or the controller supplies electric current to the first electric coil during a change in rotational speed of the vehicle engine.

A method of the invention is for controlling a magnetorheological (MR) hydraulic mount of a vehicle powertrain mounting system for a vehicle powertrain including a vehicle engine. The MR hydraulic mount operatively connects the vehicle powertrain to a vehicle weight-supporting member. The MR hydraulic mount is positioned to carry load and is positioned to react vehicle engine torque during changes in rotational speed of the vehicle engine. The MR hydraulic mount includes an electric coil. The method includes the step of supplying electric current to the electric coil during bounce of the vehicle engine. The method also includes the step of supplying electric current to the electric coil during a change in rotational speed of the vehicle engine.

Several benefits and advantages are derived from one or more of the embodiments and method of the invention. Using an MR hydraulic mount positioned to carry load and positioned to react vehicle engine torque during changes in rotational speed of the vehicle engine allows such MR hydraulic mount to replace more than one conventional mount in a conventional powertrain mounting system. In one example, the MR hydraulic mount replaces a load-carrying conventional hydraulic mount operatively connected to a rear portion of the vehicle powertrain and eliminates using upper and lower torque strut (restrictor) conventional mounts.

### SUMMARY OF THE DRAWINGS

FIG. 1 is a side-elevational schematic diagram of a first embodiment of the powertrain mounting system of the invention including a first magnetorheological (MR) hydraulic mount;

FIG. 2 is a side-elevational schematic diagram of a second embodiment of the powertrain mounting system of the invention including first and second magnetorheological (MR) hydraulic mounts; and

FIG. 3 is block diagram of a method for controlling an MR hydraulic mount of a powertrain mounting system such as that shown in the first embodiment of FIG. 1.

### DESCRIPTION OF THE PREFERRED EMBODIMENT

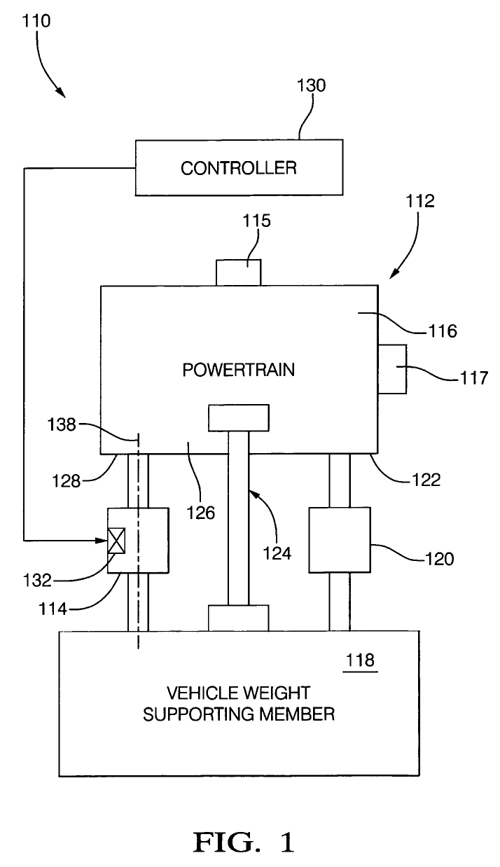

Referring now to the drawings, FIG. 1 shows a first embodiment of the present invention. A first expression of the first embodiment of FIG. 1 is for a vehicle powertrain mounting system 110 comprising a vehicle powertrain 112 and a first magnetorheological (MR) hydraulic mount 114. The vehicle powertrain 112 includes a vehicle engine 116. The first MR hydraulic mount 114 operatively connects the vehicle powertrain 112 to a vehicle weight-supporting member 118. The first MR hydraulic mount 114 is disposed to carry load and is disposed to react vehicle engine torque during a change in rotational speed of the vehicle engine 116.

In one employment of the first expression of the first embodiment of FIG. 1, the vehicle engine 116 is a transverse-mounted vehicle engine.

In an example of the first expression of the first embodiment of FIG. 1, the vehicle powertrain mounting system 110 also includes a non-MR hydraulic mount 120 operatively connected to a front portion 122 of the vehicle power train 112 and an elastomeric mount 124 operatively connected to a side portion 126 of the vehicle powertrain 112. In this example, the first MR hydraulic mount 114 is operatively connected to a rear portion 128 of the vehicle powertrain 112, and the first MR hydraulic mount 114, the non-MR hydraulic mount 120, and the elastomeric mount 124 are the only mounts operatively connected to the vehicle powertrain 112.

In one illustration of the first embodiment of FIG. 1, the first MR hydraulic mount 114 is the primary mount operatively connected to the vehicle powertrain 112 which reacts vehicle engine torque during a change in rotational speed of the vehicle engine 116. In this illustration, the first MR hydraulic mount 114 reacts more vehicle engine torque during a change in rotational speed of the vehicle engine than any other mount operatively connecting the vehicle powertrain 112 to a vehicle weight-supporting member. In one arrangement of the first embodiment of FIG. 1, the vehicle powertrain 112 is devoid of any torque-strut operative connection to a vehicle weight-supporting member.

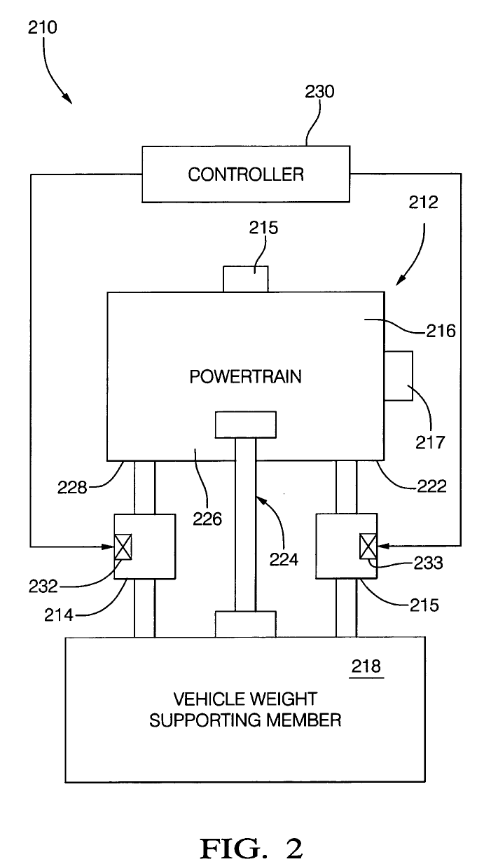

In a second embodiment shown in FIG. 2, the vehicle powertrain mounting system 210 also includes a second MR hydraulic mount 215 operatively connecting the vehicle powertrain 212 to a vehicle weight-supporting member (such as member 218 or a different vehicle weight-supporting member, not shown). The second MR hydraulic mount 215 is disposed to carry load and is disposed to react vehicle engine torque during changes in rotational speed of the vehicle engine 216. Examples of vehicle weight-supporting members include, without limitation, a vehicle frame, a vehicle subframe, and a vehicle body.

In one variation of the second embodiment of FIG. 2, the vehicle powertrain mounting system 210 also includes an elastomeric mount 224 operatively connected to a side portion 226 of the vehicle powertrain 212. In this variation, the first MR hydraulic mount 214 is operatively connected to a rear portion 228 of the vehicle powertrain 212, the second MR hydraulic mount 215 is operatively connected to a front portion 222 of the vehicle powertrain 212 and the first and second MR hydraulic mounts 214 and 215 and the elastomeric mount 224 are the only mounts operatively connected to the vehicle powertrain 212.

A second expression of the first embodiment of FIG. 1 is for a vehicle powertrain mounting system 110 comprising a vehicle powertrain 112, a first magnetorheological (MR) hydraulic mount 114, and a controller 130. The vehicle powertrain 112 includes a vehicle engine 116. The first MR hydraulic mount 114 operatively connects the vehicle powertrain 112 to a vehicle weight-supporting member 118. The first MR hydraulic mount 114 is disposed to carry load and is disposed to react vehicle engine torque during a change in rotational speed of the vehicle engine 116. The first MR hydraulic mount 114 includes a first electric coil 132. The controller 130 controls electric current to the first electric coil 132. The controller 130 supplies electric current to the first electric coil 132 during bounce of the vehicle engine 116 and/or during a change in rotational speed of the vehicle engine 116.

In one employment of the second expression of the first embodiment of FIG. 1, the vehicle engine 116 is a transverse-mounted vehicle engine.

In one example of the second expression of the first embodiment of FIG. 1, the vehicle powertrain mounting system 110 also includes a non-MR hydraulic mount 120 operatively connected to a front portion 122 of the vehicle powertrain 112 and an elastomeric mount 124 operatively connected to a side portion 126 of the vehicle powertrain 112. In this example, the first MR hydraulic mount 114 is operatively connected to a rear portion 128 of the vehicle powertrain 112, and the first MR hydraulic mount 114, the non-MR hydraulic mount 120, and the elastomeric mount 124 are the only mounts operatively connected to the vehicle powertrain 112.

In the second embodiment of FIG. 2, the vehicle powertrain mounting system 210 also includes a second MR hydraulic mount 215 operatively connecting the vehicle powertrain 212 to a vehicle weight-supporting member (such as member 218 or a different vehicle weight-supporting member, not shown). The second MR hydraulic mount 215 is disposed to carry load and is disposed to react vehicle engine torque during changes in rotational speed of the vehicle engine 216. The second MR hydraulic mount 215 includes a second electric coil 233, and the controller 230 controls electric current to the second electric coil 233. The controller 230 supplies electric current to the second electric coil 233 during bounce of the vehicle engine 216 and/or during a change in rotational speed of the vehicle engine 216. The controller 230 also controls electric current to the first electric coil 232. The controller 230 supplies electric current to the first electric coil 232 during bounce of the vehicle engine and/or during a change in rotational speed of the vehicle engine 216.

In one variation of the second embodiment of FIG. 2, the vehicle powertrain mounting system 210 also includes an elastomeric mount 224 operatively connected to a side portion 226 of the vehicle powertrain 212. In this variation, the first MR hydraulic mount 214 is operatively connected to a rear portion 228 of the vehicle powertrain 212, the second MR hydraulic mount 215 is operatively connected to a front portion 222 of the vehicle powertrain 212, and the first and second MR hydraulic mounts 214 and 215 and the elastomeric mount 224 are the only mounts operatively connected to the vehicle powertrain 212.

In one illustration of the second embodiment of FIG. 2, the first and second MR hydraulic mounts 214 and 215 are the primary mounts operatively connected to the vehicle powertrain 212 which react vehicle engine torque during a change in rotational speed of the vehicle engine 216. In this illustration, the first and second MR hydraulic mounts 214 and 215 each react more vehicle engine torque during a change in rotational speed of the vehicle engine than any other mount operatively connecting the vehicle powertrain 212 to a vehicle weight-supporting member. In one arrangement of the second embodiment of FIG. 2, the vehicle powertrain 212 is devoid of any torque-strut operative connection to a vehicle weight-supporting member.

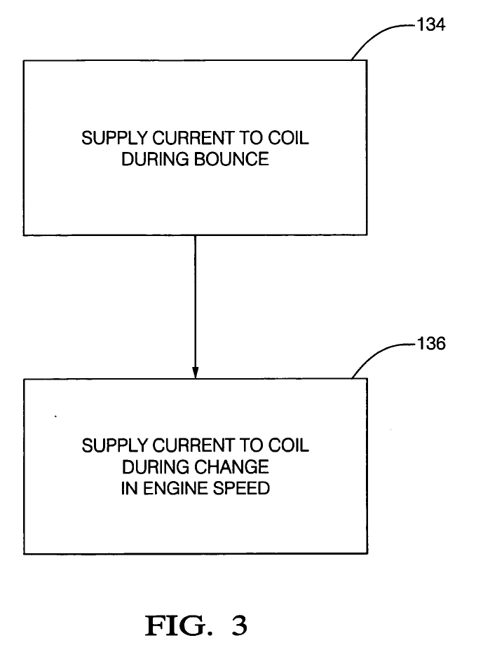

A method of the invention is shown in block-diagram form in FIG. 3 and is for controlling a magnetorheological (MR) hydraulic mount 114 (also called a first MR hydraulic mount) of a vehicle powertrain mounting system 110 for a vehicle powertrain 112 including a vehicle engine 116. The MR hydraulic mount 114 operatively connects the vehicle powertrain 112 to a vehicle weight-supporting member 118. The MR hydraulic mount 114 is disposed to carry load and is disposed to react vehicle engine torque during changes in rotational speed of the vehicle engine 116. The MR hydraulic mount 114 includes an electric coil 132 (also called a first electric coil). The method includes steps a) and b). Step a) is labeled “Supply Current To Coil During Bounce” in block 134 of FIG. 3. Step a) includes supplying electric current to the electric coil 132 during bounce of the vehicle engine 116. Step b) is labeled “Supply Current To Coil During Change In Engine Speed” in block 136 of FIG. 3. Step b) includes supplying electric current to the electric coil 132 during a change in rotational speed of the vehicle engine 116.

It is noted that the damping effect provided by the MR hydraulic mount 114 is increased with an increase in the magnitude of the electric current supplied to the electric coil 132, as can be appreciated by the artisan. In one employment of the method of FIG. 3, the vehicle engine 116 is a transverse-mounted vehicle engine. Examples of a vehicle weight-supporting member 118 include, without limitation, a vehicle frame, a vehicle subframe, and a vehicle body.

In one implementation of the method of FIG. 3, step a) supplies electric current to the electric coil 132 during bounce of the vehicle engine 116 at or above, but not below, a bounce threshold magnitude. In this implementation, step b) supplies electric current to the electric coil 132 during a change in rotational speed of the vehicle engine 116 at or above, but not below, a rotational-speed threshold magnitude.

In one extension of the method of FIG. 3, the MR hydraulic mount 114 has a longitudinal axis 138, and there is also included the step of determining a magnitude of a bounce of the vehicle engine 116 along the longitudinal axis 138. In one construction, the longitudinal axis 138 is substantially vertically aligned (i.e., substantially vertically aligned when the vehicle, not shown, is on a level horizontal surface). In one variation, bounce of the vehicle engine 116 is determined from the signal output of a position sensor, a velocity sensor, or an accelerometer, as is within the capabilities of those skilled in the art. In one modification, the signal output is filtered to control specific vibration frequencies of any vehicle components that could influence the engine bounce and/or torque reaction.

In the same or a different extension of the method of FIG. 3, there is also included the step of determining a magnitude of a change in rotational speed of the vehicle engine 116. In one variation, such change is determined from a change in the fore-aft position of the vehicle engine 116 relative to the vehicle frame, subframe or body. In another variation, such change is determined from a prediction of such change based on throttle position, braking, engine RPM (revolutions per minute), gear shifting, etc., and changes therein, as is within the capabilities of those skilled in the art.

In one application of the method of FIG. 3, the magnitude of the electric current supplied to the electric coil 132 in steps a) and b) depends on the magnitude of the bounce and/or the magnitude of the change in rotational speed. In one variation, when both bounce and change in rotational speed of the vehicle engine 116 are present, the magnitude of the supplied electric current depends on the magnitude of the bounce or the magnitude of the change in rotational speed having the greater effect on vehicle performance, as can be appreciated by the artisan. In the same or a different application, a different magnitude of electric current is supplied to the electric coil for compression than for extension of the MR hydraulic mount 114.

Several benefits and advantages are derived from one or more of the embodiments and method of the invention. Using an MR hydraulic mount positioned to carry load and positioned to react vehicle engine torque during changes in rotational speed of the vehicle engine allows such MR hydraulic mount to replace more than one conventional mount in a conventional powertrain mounting system. In one example, the MR hydraulic mount replaces a load-carrying conventional hydraulic mount operatively connected to a rear portion of the vehicle powertrain and eliminates using upper and lower torque strut (restrictor) conventional mounts.

The foregoing description of several embodiments and a method of the invention has been presented for purposes of illustration. It is not intended to be exhaustive or to limit the invention to the precise form and steps disclosed, and obviously many modifications and variations are possible in light of the above teaching. It is intended that the scope of the invention be defined by the claims appended hereto.

1-8. (canceled)

9. A vehicle powertrain mounting system comprising:
a) a vehicle powertrain including a vehicle engine;
b) a first magnetorheological (MR) hydraulic mount operatively connecting the vehicle powertrain to a vehicle weight-supporting member, wherein the first MR hydraulic mount is disposed to carry load and is disposed to react vehicle engine torque during changes in rotational speed of the vehicle engine, and wherein the first MR hydraulic mount includes a first electric coil; and
c) a controller which controls electric current to the first electric coil, wherein the controller supplies electric current to the first electric coil based upon determining bounce of the vehicle engine and based upon determining a change in rotational speed of the vehicle engine.

10. The vehicle powertrain mounting system of claim 9 wherein the first MR hydraulic mount reacts more vehicle engine torque during a change in rotational speed of the vehicle engine than any other mount operatively connecting the vehicle powertrain to any vehicle weight-supporting member.

11. The vehicle powertrain mounting system of claim 9, wherein the vehicle powertrain is devoid of any torque-strut operative connection to any vehicle weight-supporting member.

12. The vehicle powertrain mounting system of claim 9, wherein the vehicle engine is a transverse-mounted vehicle engine.

13. The vehicle powertrain mounting system of claim 9, also including a hydraulic mount operatively connected to a front portion of the vehicle power train and an elastomeric mount operatively connected to a side portion of the vehicle powertrain, wherein the first MR hydraulic mount is operatively connected to a rear portion of the vehicle powertrain, wherein the first MR hydraulic mount, the non-magnetorheological hydraulic mount, and the elastomeric mount are the only mounts operatively connected to the vehicle powertrain, and wherein the hydraulic mount is not MR.

14. The vehicle powertrain mounting system of claim 9, also including a second MR hydraulic mount operatively connecting the vehicle powertrain to the vehicle weight-supporting member or to any other vehicle weight-supporting member, wherein the second MR hydraulic mount is disposed to carry load and is disposed to react vehicle engine torque during changes in rotational speed of the vehicle engine, wherein the second MR hydraulic mount includes a second electric coil, wherein the controller controls electric current to the second electric coil, and wherein the controller supplies electric current to the second electric coil based upon determining bounce of the vehicle engine and/or during a change in rotational speed of the vehicle engine.

15. The vehicle powertrain mounting system of claim 14, wherein the vehicle engine is a transverse-mounted vehicle engine.

16. The vehicle powertrain mounting system of claim 15, also including an elastomeric mount operatively connected to a side portion of the vehicle powertrain, wherein the first MR hydraulic mount is operatively connected to a rear portion of the vehicle powertrain, wherein the second MR hydraulic mount is operatively connected to a front portion of the vehicle powertrain, and wherein the first and second MR hydraulic mounts and the elastomeric mount are the only mounts operatively connected to the vehicle powertrain.

17. A method for controlling a magnetorheological (MR) hydraulic mount of a vehicle powertrain mounting system for a vehicle powertrain including a vehicle engine, wherein the MR hydraulic mount operatively connects the vehicle powertrain to a vehicle weight-supporting member, wherein the MR hydraulic mount is disposed to carry load and is disposed to react vehicle engine torque during a change in rotational speed of the vehicle engine, wherein the MR hydraulic mount includes an electric coil, and wherein the method includes the steps of:
a) supplying electric current to the electric coil based upon determining bounce of the vehicle engine; and
b) supplying electric current to the electric coil based upon determining a change in rotational speed of the vehicle engine.

18. The method of claim 17, wherein the vehicle engine is a transverse-mounted vehicle engine.

19. The method of claim 18, wherein the vehicle weight-supporting member is chosen from the group consisting of a vehicle frame, a vehicle subframe, and a vehicle body.

20. The method of claim 17, wherein step a) supplies electric current to the electric coil during bounce of the vehicle engine at or above, but not below, a bounce threshold magnitude, and wherein step b) supplies electric current to the electric coil during a change in rotational speed of the vehicle engine at or above, but not below, a rotational-speed threshold magnitude.

21. The method of claim 18, wherein the MR hydraulic mount has a longitudinal axis, and also including the step of determining a magnitude of the bounce of the vehicle engine along the longitudinal axis.

22. The method of claim 21, also including the step of determining a magnitude of the change in rotational speed of the engine.

23. The method of claim 17, wherein the magnitude of the electric current supplied to the electric coil in steps a) and b) depends on the magnitude of the bounce and/or the magnitude of the change in rotational speed.

24. The method of claim 23, wherein a different magnitude of electric current is supplied to the electric coil for compression than for extension of the MR hydraulic mount.
